(19) United States
(12) Patent Application Publication
(10) Pub. No.: US 2025/0289420 A1
(43) Pub. Date: Sep. 18, 2025

(54) CONTROL APPARATUS, CONTROL METHOD THEREOF, AND STORAGE MEDIUM

(71) Applicant: HONDA MOTOR CO., LTD., Tokyo (JP)

(72) Inventor: Kotaro FUJIMURA, Wako-shi (JP)

(21) Appl. No.: 19/056,576

(22) Filed: Feb. 18, 2025

(30) Foreign Application Priority Data
Mar. 18, 2024 (JP) 2024-042302

(51) Int. Cl. B60W 30/09; B60W 10/20; G08G 1/16

(52) U.S. Cl. CPC B60W 30/09; B60W 10/20; G08G 1/16; B60W 2552/30; B60W 2710/20; B60W 2720/10

(57) ABSTRACT

A control apparatus recognizes a state of a target outside a moving object, recognizes a traveling lane on a movement route on which the moving object travels, and generates information of a virtual traveling lane which is a straight traveling lane on the basis of information of the recognized traveling lane and a state of the recognized target; the apparatus sets, on the virtual traveling lane, a search region for calculating a risk, and calculates the risk in the set search region. In a case where the traveling lane has a road shape including a curved shape, the apparatus converts each position of the traveling lane so that a curved portion of the traveling lane becomes a straight traveling lane along a traveling direction, and generates information of the virtual traveling lane.

### CROSS-REFERENCE TO RELATED APPLICATION(S)

This application claims priority to and the benefit of Japanese Patent Application No. 2024-042302, filed Mar. 18, 2024, the entire disclosure of which is incorporated herein by reference.

### BACKGROUND OF THE INVENTION

### Field of the Invention

The present invention relates to a control apparatus, a control method thereof, and a storage medium.

### Description of the Related Art

Conventionally, as a technique for generating an appropriate travel trajectory according to a travel environment when a moving object such as a vehicle travels, there has been known a technique in which, when the traveling track is a curved road, a target potential region set on a straight road is set differently on the basis of a curvature radius of the curved road (Japanese Patent Laid-Open No. 2019-46161).

The technique according to Japanese Patent Laid-Open No. 2019-46161 uses a highly accurate curvature of the curved road previously included in map information. On the other hand, there is a case where the map information does not include the curvature of each curve of the traveling path, or a case where the moving object travels while recognizing the surrounding environment without using satisfactory map information. In the processing of calculating the curvature of the traveling path, the calculation accuracy may decrease due to the behavior of the vehicle. For this reason, in a case where the curvature of the traveling path is estimated, and the determination of the risk (referred to as index value indicating degree to which vehicle should avoid entry) according to the curve or the notification according to the risk is performed using the estimated curvature, the processing becomes complicated, and the determination of the risk and the accuracy of the notification may decrease.

### SUMMARY OF THE INVENTION

The present invention has been made in view of the above problems, and an object thereof is to implement a technique capable of suppressing a decrease in accuracy in risk calculation even when traveling on a movement route having a road shape including a curved shape.

In order to solve the aforementioned issues, one aspect of the present disclosure provides a control apparatus comprising: one or more processors; and a memory storing instructions which, when the instructions are executed by the one or more processors, cause the control apparatus to function as: a target recognition unit configured to recognize a state of a target outside a moving object; a traveling lane recognition unit configured to recognize a traveling lane on a movement route on which the moving object travels; a generation unit configured to generate information of a virtual traveling lane which is a straight traveling lane on the basis of information of the recognized traveling lane and a state of the recognized target; a setting unit configured to set, on the virtual traveling lane, a search region for calculating a risk that is an index value indicating a degree to which the moving object should avoid entry; and a calculation unit configured to calculate the risk in the set search region, wherein in a case where the traveling lane has a road shape including a curved shape, the generation unit converts each position of the traveling lane so that a curved portion of the traveling lane becomes a straight traveling lane along a traveling direction, and generates information of the virtual traveling lane.

Still another aspect of the present disclosure provides a control method of a control apparatus comprising: recognizing a state of a target outside a moving object; recognizing a traveling lane on a movement route on which the moving object travels; generating information of a virtual traveling lane which is a straight traveling lane on the basis of information of the recognized traveling lane and a state of the recognized target; setting, on the virtual traveling lane, a search region for calculating a risk that is an index value indicating a degree to which the moving object should avoid entry; and calculating the risk in the set search region, wherein in the generating, in a case where the traveling lane has a road shape including a curved shape, each position of the traveling lane is converted so that a curved portion of the traveling lane becomes a straight traveling lane along a traveling direction, and information of the virtual traveling lane is generated.

Yet another aspect of the present disclosure provides a non-transitory computer-readable storage medium storing a program for performing the control method of the control apparatus, the control method comprising: recognizing a state of a target outside a moving object; recognizing a traveling lane on a movement route on which the moving object travels; generating information of a virtual traveling lane which is a straight traveling lane on the basis of information of the recognized traveling lane and a state of the recognized target; setting, on the virtual traveling lane, a search region for calculating a risk that is an index value indicating a degree to which the moving object should avoid entry; and calculating the risk in the set search region, wherein in the generating, in a case where the traveling lane has a road shape including a curved shape, each position of the traveling lane is converted so that a curved portion of the traveling lane becomes a straight traveling lane along a traveling direction, and information of the virtual traveling lane is generated.

According to the present invention, it is possible to suppress a decrease in accuracy in risk calculation even when traveling on a movement route having a road shape including a curved shape.

### BRIEF DESCRIPTION OF THE DRAWINGS

FIG. 1 is a diagram illustrating a configuration example of a vehicle as an example of a moving object according to an embodiment;

FIG. 2 is a block diagram illustrating a functional configuration example of a control apparatus according to the embodiment;

FIG. 3 is a diagram for describing an outline of risk calculation according to the embodiment;

FIG. 4 is a flowchart illustrating a series of operations of driving assistance processing according to the embodiment;

FIG. 5 is a diagram for describing an example of processing of determining a road shape including a curved shape according to the embodiment;

FIG. 6 is a diagram for describing an example of processing of determining a relationship with a traveling road boundary according to the embodiment;

FIG. 7 is a diagram for describing an example of processing of estimating a curvature of a curve according to the embodiment;

FIG. 8 is a diagram for describing an example of processing of converting a position of a target according to the embodiment; and

FIG. 9 is a diagram for describing an example of a risk to a target according to the embodiment.

### DESCRIPTION OF THE EMBODIMENTS

Hereinafter, embodiments will be described in detail with reference to the attached drawings. Note that the following embodiments are not intended to limit the scope of the claimed invention, and limitation is not made an invention that requires all combinations of features described in the embodiments. Two or more of the multiple features described in the embodiments may be combined as appropriate. Furthermore, the same reference numerals are given to the same or similar configurations, and redundant description thereof is omitted.

### <Vehicle Configuration Example>

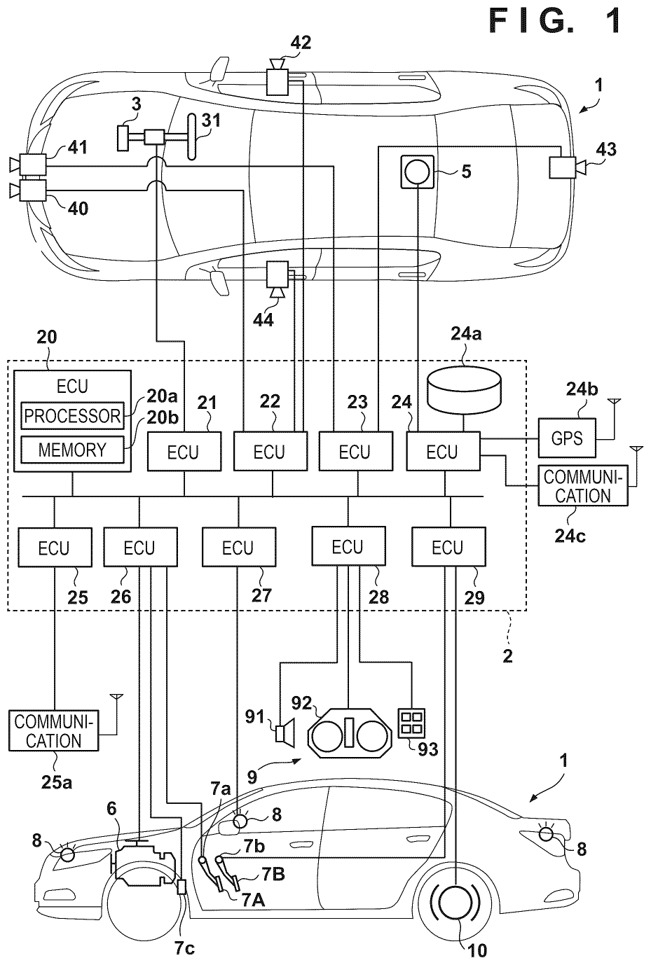

FIG. 1 is a block diagram of a vehicle 1 as an example of a moving object according to the present invention. In FIG. 1, an outline of the vehicle 1 is illustrated in a plan view and in a side view. The vehicle 1 is, for example, a four-wheeled passenger vehicle, but may be a two-wheeled vehicle or another type of vehicle. In addition, the moving object according to the present invention is not limited to a vehicle, and may include various moving objects such as a robot that autonomously travels.

The vehicle 1 includes a vehicle control apparatus (hereinafter simply referred to as control apparatus 2) that controls the vehicle 1. The control apparatus 2 includes a plurality of electronic control units (ECUs) 20 to 29 connected to be able to communicate with each other through an in-vehicle network. Each ECU includes a processor such as a central processing unit (CPU) or a graphics processing unit (GPU), a memory such as a semiconductor memory, an interface with an external device, and the like. The memory stores programs executed by the processor, data used for processing by the processor, and the like. Each of the ECUs may include a plurality of processors, memories, interfaces, and the like. For example, the ECU 20 includes a processor 20a and a memory 20b. Processing by the ECU 20 is performed by the processor 20a executing instructions included in a program stored in the memory 20b. Instead of this, the ECU 20 may include an integrated circuit such as an application specific integrated circuit (ASIC) dedicated to performing processing by the ECU 20. A similar configuration applies to the other ECUs.

Hereinafter, functions and the like to be performed by the ECUs 20 to 29 will be described. Note that the number of ECUs and functions assigned to the ECUs can be appropriately designed, and can be subdivided or integrated as compared with those in the present embodiment. For example, one ECU (e.g., ECU 22) may have the function of another ECU.

The ECU 20 executes control related to manual traveling and automated traveling of the vehicle 1. In automated traveling, at least one of steering and acceleration or deceleration of the vehicle 1 is automatically controlled. Note that the automated traveling by the ECU 20 may include automated traveling that does not require the driver to perform a traveling operation (which may also be referred to as automated driving) and automated traveling for assisting the driver in performing the traveling operation (which may also be referred to as driving assistance). The control of traveling by the ECU 20 may include, for example, control of automatically stopping or steering the vehicle in order to avoid a collision instead of driving by the driver.

The ECU 21 controls an electric power steering device 3. The electric power steering device 3 includes a mechanism that steers front wheels in accordance with a driver's driving operation (steering operation) on a steering wheel 31. In addition, the electric power steering device 3 includes a motor that exerts a driving force for assisting the steering operation or automatically steering the front wheels, a sensor that detects a steering angle, and the like. In a case where the driving state of the vehicle 1 is automated driving, the ECU 21 automatically controls the electric power steering device 3 in response to an instruction from the ECU 20, and controls an advancing direction of the vehicle 1.

The ECUs 22 and 23 control detection units for detecting the surrounding situation of the vehicle and performs information processing on detection results. The vehicle 1 includes, for example, one standard camera 40 and four fisheye cameras 41 to 44 as a detection unit that detects the surrounding situation of the vehicle. The standard camera 40 and the fisheye cameras 42 and 44 are connected to the ECU 22. The fisheye cameras 41 and 43 are connected to the ECU 23. The ECUs 22 and 23 can recognize the state of the target such as the type, position, and speed of the target, the lane region on the movement route, the traveling road boundary (white line), and the dividing line (broken line or the like) between lanes by analyzing the images captured by the standard camera 40 and the fisheye cameras 41 to 44. Note that the type, number, and mounting position of the camera included in the vehicle 1 are not limited to the example of the present embodiment, and the camera may have other configurations. In addition, the vehicle 1 may include a light detection and ranging (LiDAR) or a millimeter wave radar as a detection unit for detecting a target around the vehicle 1 and measuring a distance to the target.

The standard camera 40 is attached at the center in a front part of the vehicle 1, and captures an image of a surrounding situation ahead of the vehicle 1. The fisheye camera 41 is attached at the center in the front part of the vehicle 1, and captures an image of a surrounding situation ahead of the vehicle 1. In FIG. 1, the standard camera 40 and the fisheye camera 41 are shown as being aligned horizontally. However, the arrangement of the standard camera 40 and the fisheye camera 41 is not so limited, and they may be aligned vertically, for example. In addition, at least one of the standard camera 40 and the fisheye camera 41 may be attached to a front portion of the roof (for example, on the vehicle interior side of the windshield) of the vehicle 1. The fisheye camera 42 is attached at the center in a right lateral side part of the vehicle 1, and captures an image of a surrounding situation on the right side of the vehicle 1. The fisheye camera 43 is attached at the center in a rear part of the vehicle 1, and captures an image of a surrounding situation behind the vehicle 1. The fisheye camera 44 is attached at the center in a left lateral side part of the vehicle 1, and captures an image of a surrounding situation on the left side of the vehicle 1.

The ECU 22 controls the standard camera 40 and the fisheye cameras 42 and 44 and performs information processing on detection results. The ECU 23 controls the fisheye cameras 41 and 43 and performs information processing on detection results. The detection unit that detects the surrounding situation of the vehicle is divided into two systems, and therefore the reliability of the detection results can be improved. In addition, the ECU 22 can detect the direction of the head and the line of sight of the driver using an image obtained by imaging the driver with a fisheye camera (not illustrated) installed in the vehicle interior.

The ECU 24 controls a gyro sensor 5, a GPS sensor 24b, and a communication device 24c, and performs information processing on detection results or communication results. The gyro sensor 5 detects a rotational movement of the vehicle 1. A course of the vehicle 1 can be determined on the basis of a detection result of the gyro sensor 5, a wheel speed, and the like. The GPS sensor 24b detects a current location of the vehicle 1. The communication device 24c performs wireless communication with a server that provides map information and traffic information, and acquires these pieces of information. The ECU 24 is capable of accessing a map information database 24a, which is constructed in a memory, and the ECU 24 performs route search and the like from the current location to a destination. The ECU 24, the map database 24a, and the GPS sensor 24b constitute a so-called navigation device.

The ECU 25 includes a communication device 25a for inter-vehicle communication. The communication device 25a performs, for example, wireless communication with other surrounding vehicles to exchange information between the vehicles.

The ECU 26 controls a power plant 6. The power plant 6 is a mechanism that outputs a driving force for rotating driving wheels of the vehicle 1, and includes, for example, an engine and a transmission. For example, the ECU 26 controls the output of the engine in accordance with a driver's driving operation (operation on accelerator or acceleration operation) that is detected by an operation detection sensor 7a provided on an accelerator pedal 7A, and switches between the gear ratios of the transmission on the basis of information such as the vehicle speed detected by a vehicle speed sensor 7c.

The ECU 27 controls lighting devices (headlights, taillights, and the like) including direction indicators 8 (blinkers). In the example of FIG. 1, the direction indicators 8 are provided at the front part, door mirrors, and the rear part of the vehicle 1.

The ECU 28 controls an input and output device 9. The input and output device 9 outputs information to a passenger (for example, a driver) and receives an input of information from the driver. A voice output device 91 notifies the driver of information by, for example, a voice including a predetermined sound or utterance. The notification content is output, for example, when the ECU 22 performs driving assistance processing to be described later, determines execution of notification, and transmits the notification content to the ECU 28. The driving assistance processing will be described later. A display device 92 notifies the driver of information by displaying an image. The display device 92 is disposed, for example, in front of a driver's seat, and constitutes an instrument panel or the like. Note that, although the voice and the display have been given as examples here, information may also be notified by vibration or light. In addition, information may be notified by a combination of two or more of voice, display, vibration, and light. An input device 93 is a group of switches that are disposed at positions for the driver to be able to operate and give an instruction to the vehicle 1, but may also include a voice input device.

The ECU 29 controls a brake device 10 and a parking brake (not illustrated). The brake device 10 is, for example, a disc brake device, and is provided on each wheel of the vehicle 1 to apply resistance against rotations of the wheels to decelerate or stop the vehicle 1. The ECU 29 controls the activation of the brake device 10 in response to a driver's driving operation (braking operation) detected by an operation detection sensor 7b, which is provided on a brake pedal 7B, for example. When the driving state of the vehicle 1 is automated driving, the ECU 29 automatically controls the brake device 10 in response to an instruction from the ECU 20 to control the vehicle 1 to be decelerated and stopped. The brake device 10 and the parking brake can also be activated to maintain the stopped state of the vehicle 1. In addition, in a case where the transmission of the power plant 6 includes a parking lock mechanism, it is also possible to activate the parking lock mechanism to maintain the stopped state of the vehicle 1.

### <Functional Configuration Example Implemented in ECU 22>

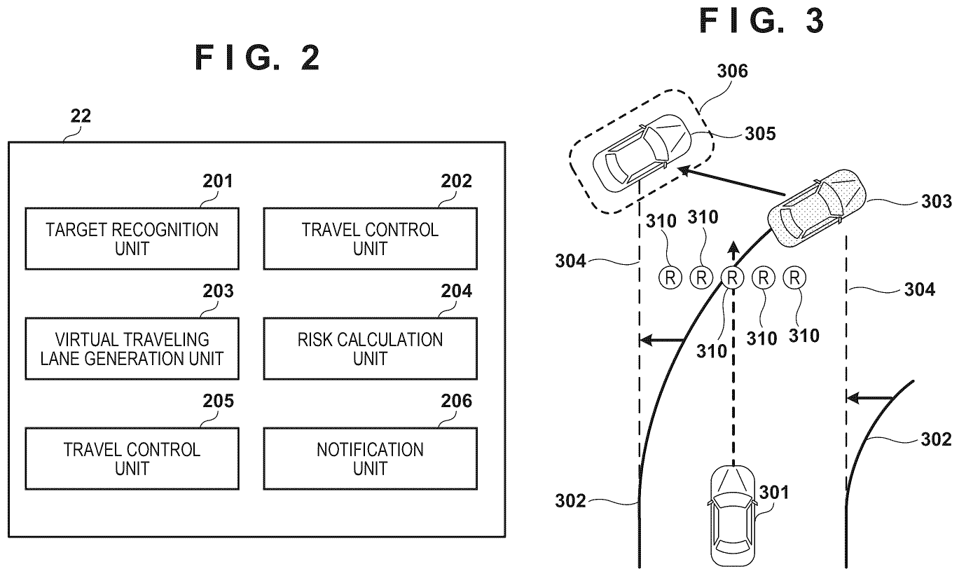

Next, a functional configuration example implemented in the ECU 22 will be described with reference to FIG. 2. Note that some or all of the functions described below as functions implemented in the ECU 22 may be implemented in another ECU (for example, the ECU 20). The functional configuration example illustrated in FIG. 2 illustrates an example of a functional configuration implemented by the ECU 22 executing a program stored in an internal memory. In addition, the functional configuration example illustrated in FIG. 2 focuses on a configuration related to driving assistance processing to be described later. Therefore, the functions implemented in the ECU 22 are not limited to those illustrated in FIG. 2 and may include other functions.

A target recognition unit 201 recognizes the state of the target outside the vehicle 1 on the basis of at least one of the image obtained from the detection unit and sensor information of a LiDAR or the like. The target includes, for example, a moving object (a peripheral vehicle or a passerby such as a pedestrian or a person riding a bicycle) or a falling object around the vehicle 1. The state of the target includes, for example, the type of the target, the position of the target, the speed of the target, the movement track of the target, and the like. The position of the target may be a relative position from the vehicle 1. The target recognition unit 201 can recognize the state of the target in the external world using, for example, one or more neural networks, but may use another learning model.

A traveling lane recognition unit 202 recognizes the traveling lane on the movement route on which the vehicle 1 travels on the basis of at least one of the image obtained from the detection unit and sensor information of the LiDAR or the like. The information of the recognized traveling lane includes, for example, information of a traveling road boundary, a dividing line, and a lane region on the movement route. The information of the traveling road boundary and the dividing line may be given by, for example, position information of a discrete point group at every predetermined distance (for example, every one meter). The traveling lane recognition unit 202 can recognize the traveling lane on the movement route by, for example, one or more neural networks, but may use another learning model. Note that the function of the target recognition unit 201 and the function of the traveling lane recognition unit 202 may be implemented by one neural network or learning model.

The traveling lane recognition unit 202 further determines whether the traveling lane has a predetermined road shape including a curved shape by using information on a traveling road boundary of the traveling lane. The determination as to whether the predetermined road shape is formed will be described later.

FIG. 3 illustrates an outline of driving assistance processing according to the present embodiment. In the example illustrated in FIG. 3, a vehicle 301 (that is, the vehicle 1) which is the self-vehicle is traveling in a traveling lane 302 on the movement route, and a vehicle 303 is stopped on the traveling lane 302. The traveling lane 302 illustrated in FIG. 3 is a traveling lane having a road shape including a curved shape. Note that in the example illustrated in FIG. 3, the curvature of the traveling lane 302 is increased for the sake of explanation. However, in the driving assistance processing of the present embodiment, as will be described later, the main processing is executed when a vehicle travels in a traveling lane having a gentle curvature with a curvature radius of 100 R or more.

In a case where the vehicle 301 is traveling in the traveling lane 302, the target recognition unit 201 recognizes the state of the target including the position, speed, movement track, and the like of the vehicle 303. In addition, the traveling lane recognition unit 202 recognizes a traveling road boundary, a dividing line, and a lane region of the traveling lane 302.

A virtual traveling lane generation unit 203 generates information of a virtual traveling lane which is a straight traveling lane on the basis of the information of the traveling lane recognized by the target recognition unit 201 and the state of the target recognized by the traveling lane recognition unit 202.

In the example illustrated in FIG. 3, the virtual traveling lane generation unit 203 converts each position of the traveling lane 302 so that the curved portion of the traveling lane 302 becomes a straight traveling lane (that is, a traveling lane 304) along the traveling direction, and generates information of the virtual traveling lane. As described above, since the traveling lane 302 curves with a gentle curvature having a curvature radius of, for example, 100 R or more, it is possible to perform processing of approximating information of the traveling lane 302 to a straight traveling lane. The virtual traveling lane generation unit 203 generates a straight line constituting the virtual traveling lane 304 by, for example, drawing a straight line in the traveling direction from the average position of a point group in a predetermined range of a traveling road boundary existing on the left side (or the right side) of the vehicle 301. The conversion of each position of the traveling lane 302 may be processing of moving (mapping) each position in a direction perpendicular to the traveling direction. Note, however, that when each position of the traveling lane 302 is moved in a direction perpendicular to the traveling direction, the distance on the virtual traveling lane 304 may be shorter than the actual distance on the traveling lane 302. Therefore, in addition to moving each position in a direction perpendicular to the traveling direction, the position of the target may be offset such that the position of the target moves away from the position of the vehicle 301 in the traveling direction of the vehicle 301 on the virtual traveling lane 304. In this way, the positional relationship between the vehicle 301 and the target in the traveling lane 302 can be more accurately reflected on the virtual traveling lane 304 by simple calculation. In this way, by generating a virtual traveling lane which is a straight traveling lane, it is not necessary to perform processing specific to a curved road according to curvature when calculating a risk and notifying the driver as described later. That is, the processing for calculating the risk and notifying the driver can be simplified and speeded up. In addition, since conversion using an estimated curvature is not performed, it is possible to suppress a decrease in processing accuracy.

A risk calculation unit 204 calculates a risk that is an index value indicating a degree to which the vehicle should avoid entry. The risk for a specific target takes a more negative value (the degree to which entry should be avoided increases) as it is closer to the recognized target, and decreases and reaches zero as it is farther from the target. The risk calculation unit 204 sets a search region for calculating the risk on the virtual traveling lane. The search region includes, for example, a first observation point set on the traveling direction side of the vehicle 301 and one or more second observation points (two in the example described later) in each of the left and right directions with respect to the first observation point as viewed from the vehicle 301. By calculating a risk at each observation point in the search region using these observation points as a group and searching for the lowest risk among the calculated risks, a traveling track with the lowest risk can be obtained. Note that in the illustrated example, one observation point is set at a predetermined position from the vehicle 301 on the traveling direction side. However, a plurality of observation points can be arranged on the traveling direction side, and a plurality of observation points can be set in each of the left and right directions with respect to each observation point. In this way, it is possible to grasp the risk existing in a specific direction or position on the traveling lane. Note that in the following description, calculating the risk at each observation point in the search region is also simply referred to as calculating the risk in the search region.

The risk calculation unit 204 sets a risk potential on a virtual traveling lane. The setting of the risk potential may be achieved using a known technique. The risk potential may be a combination of a risk potential set for the traveling lane and a risk potential caused by the presence of the target, or may be only the risk potential caused by the presence of the target.

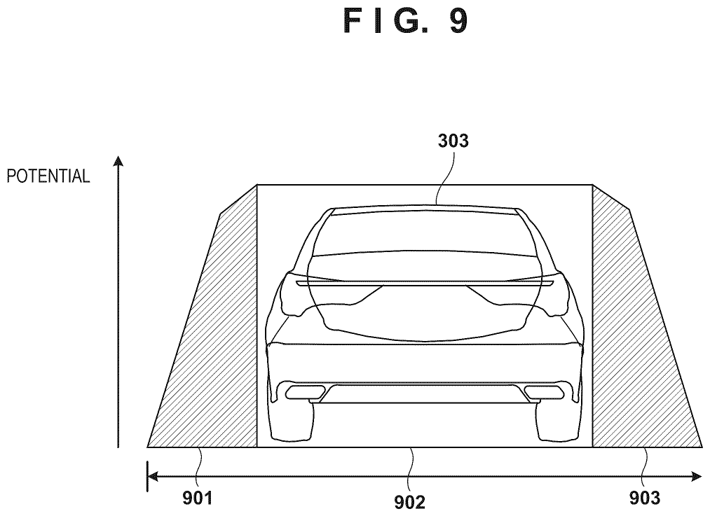

FIG. 9 schematically illustrates an example of a risk potential generated by the presence of a target (for example, the vehicle 303). The vertical axis indicates the level of risk, and the horizontal axis indicates the position of the vehicle 303 in the left-right direction. In a range 902 proximate to the vehicle 303, the risk potential indicates the highest value of the risks set for the vehicle 303. In a range 901 and a range 902, the risk decreases as the distance from the center of the vehicle 303 increases. A similar risk potential may be set at the front and back of the vehicle 303. The risk potential set for the target is also referred to as a target potential or the like. When the search region for calculating the risk is present in the ranges 901 to 903, the risk increases due to the presence of the vehicle 303. On the other hand, when the search region does not overlap the ranges 901 to 903, the risk does not increase due to the presence of the vehicle 303.

The risk potential set for the traveling lane, for example, is set so that the risk value is lowest in the center of the traveling lane, and the farther from the center (the closer to the traveling road boundary), the higher the value. Such a risk potential is also referred to as an induced potential or the like. When such a risk potential is used, the risk is lowest near the center of the traveling lane in the search region. In addition, the risk increases near the traveling road boundary in the search region.

FIG. 3 is referred to again. In the example of FIG. 3, an observation point 310 in the search region is set at a predetermined distance from the vehicle 301. In a case where the vehicle 301 moves forward in the virtual traveling lane, the observation point 310 on the left side of the search region is located in the range of a risk potential 306 of a vehicle 305 (that is, the vehicle 303). In this case, the risk calculation unit 204 combines the risk of the risk potential 306 to calculate the risk in the search region. In this way, the risk calculated in the search region is a value of the risk including the influence of the target. Note that when a plurality of targets is present, the risk potentials of the targets are combined. In a case where the distance to two targets from the observation point 310 on the left side of the search region is short and the risk potential of each target is not zero at the position of the observation point 310, the risk potentials of the targets are combined. That is, the risk calculation unit 204 calculates the risk in the search region on the basis of the combined risk potential. In this way, it is possible to determine an action of the vehicle such as automated traveling or notifying the driver on the basis of the risk calculated in the search region.

A travel control unit 205 determines an action of the vehicle on the basis of the risk calculated in the search region. For example, the travel control unit 205 determines the travel route of the vehicle 301 so as to travel at the position of the observation point at which the lowest risk is calculated. Furthermore, the travel control unit 205 controls at least one of the speed and steering of the vehicle 301 so that the vehicle 301 automatically travels according to the determined travel route. Of course, the travel control unit 205 can perform various types of control necessary for automated traveling on the determined travel route, in addition to speed and steering. The automated traveling may include automated traveling of the vehicle 301 that does not require a traveling operation by the driver or automated traveling for assisting the traveling operation by the driver.

A notification unit 206 notifies the driver on the basis of the risk calculated in the search region. When the risk in the search region (at any observation point) exceeds a predetermined value, the notification unit 206 notifies the driver of a predetermined warning sound or a voice using a natural language (including an expression representing a recognized target). For example, in a case of notifying a voice, the notification unit 206 includes at least one of presence or absence, a position, a direction, and a distance of a target with which there is the possibility of collision, and a time until collision with the target. The notification unit 206 may display the contents to be notified on the display device 92. For example, the notification unit 206 includes, on the display device 92, at least one of presence or absence, a position, a direction, and a distance of a target with which there is the possibility of a collision, and a time until collision with the target. The notification unit 206 may notify the driver in a case where the distance from the vehicle 301 to the target is equal to or less than a predetermined distance or the arrival time to the target is equal to or less than a predetermined time.

Note that the above-described risk may correspond to a possibility of collision between the vehicle 301 and another target (vehicle 303). At this time, the travel control unit 205 or the notification unit 206 determines an action of the moving object on the basis of a possibility of collision between the vehicle 301 and another target (vehicle 303).

### <Series of Operations of Driving Assistance Processing in Vehicle>

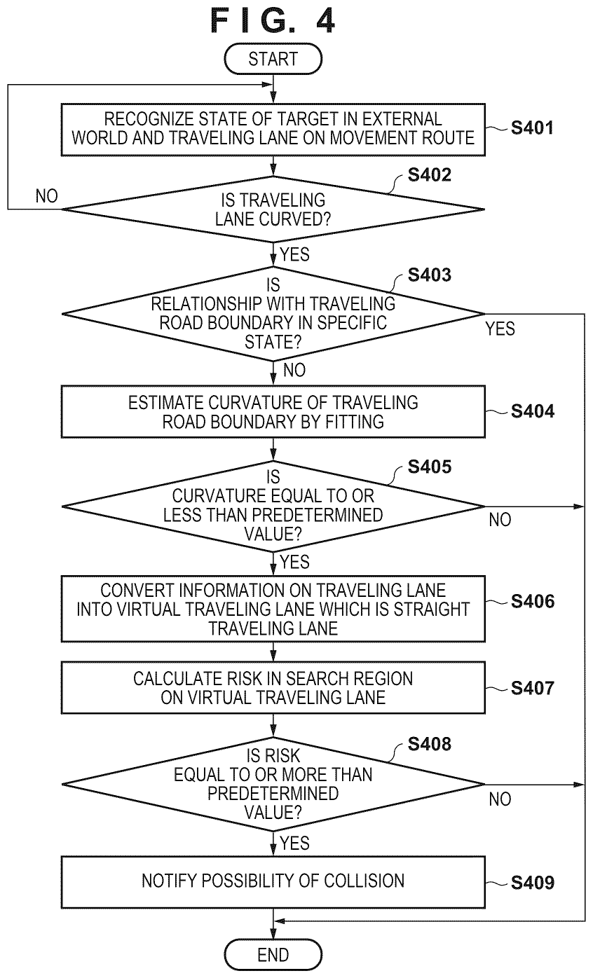

Next, with reference to FIG. 4, a series of operations of the driving assistance processing in a vehicle will be described. This processing is implemented, for example, by the processor 20a of the ECU 22 of the control apparatus 2 executing a program in the memory 20b.

In S401, the target recognition unit 201 recognizes the state of the target outside the vehicle 1 on the basis of at least one of the image obtained from the detection unit and sensor information of a LiDAR or the like. In addition, the traveling lane recognition unit 202 recognizes the traveling lane on the movement route on which the vehicle 1 travels on the basis of at least one of the image obtained from the detection unit and sensor information of the LiDAR or the like.

Next, by the processing of S402 to S405, the traveling lane recognition unit 202 determines whether the traveling lane has a predetermined road shape including a curved shape. First, in S402, the traveling lane recognition unit 202 determines whether the traveling lane is curved.

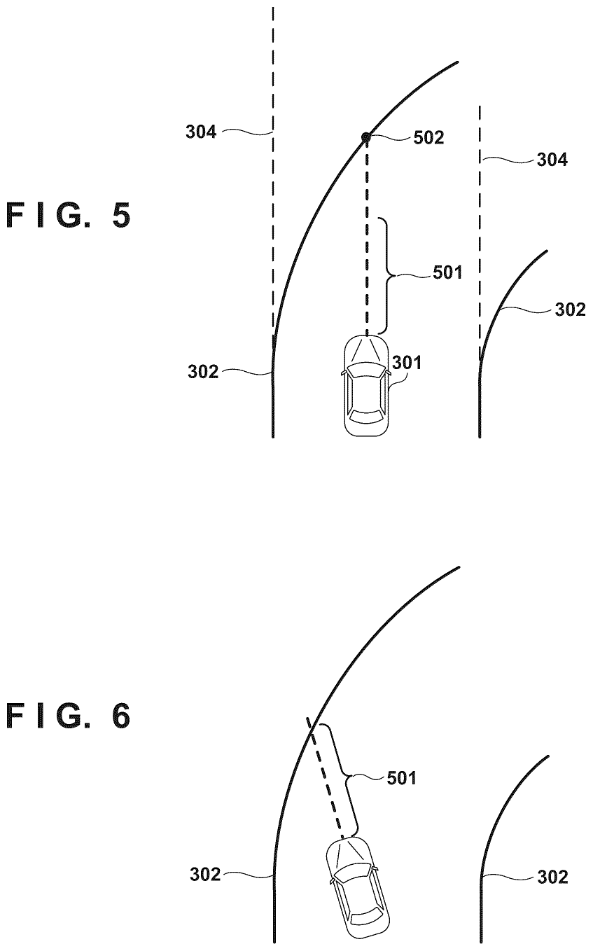

FIG. 5 schematically illustrates an example in which the traveling lane is curved. The example illustrated in FIG. 5 illustrates a case where there is a traveling road boundary in the traveling direction of the vehicle 301 (because the traveling lane includes a curved road). In this example, the traveling road boundary is at a position 502 that is more distant than a distance 501 (20 meters, for example) from the vehicle 301. When a traveling road boundary exists in the traveling direction, the traveling lane recognition unit 202 determines that the traveling lane is curved. When determining that the traveling lane is curved, the traveling lane recognition unit 202 advances the processing to S403, and if not, returns the processing to S401.

In S403, the traveling lane recognition unit 202 determines whether the positional relationship between the traveling road boundary and the vehicle is in a specific state. FIG. 6 schematically illustrates an example in which the relationship with the traveling road boundary is in a specific state. In the example illustrated in FIG. 6, a traveling road boundary exists at a position at a distance of 501 or less from the vehicle. Such a state may be a case where the vehicle is deviating from the road, for example, turning right or left or entering a parking lot. Therefore, in the present embodiment, in such a specific state, the driving assistance processing is terminated. When the traveling road boundary exists at a position at a distance of 501 or less from the vehicle, the traveling lane recognition unit 202 determines that the traveling road boundary is in a specific state and terminates the processing, and if not, advances the processing to S404.

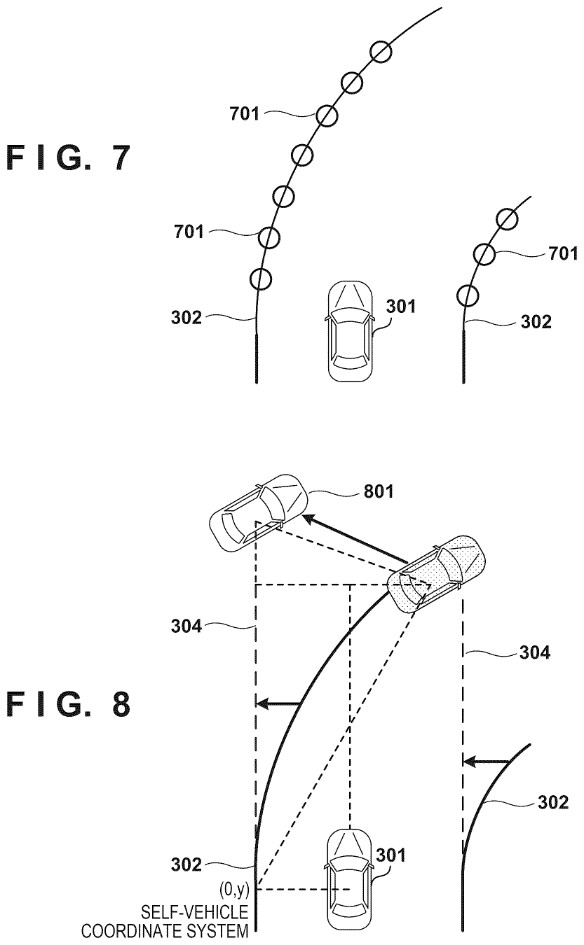

In S404, the traveling lane recognition unit 202 estimates the curvature of the traveling road boundary of the traveling lane by fitting the traveling road boundary of the traveling lane with an arc. FIG. 7 schematically illustrates fitting of a traveling road boundary with an arc. In this example, the traveling road boundary of the traveling lane 302 is given by position information 701 of a discrete point group for each predetermined distance (for example, every 1 meter). For example, the traveling lane recognition unit 202 estimates a parameter of an arc that most matches the position information 701 of the point group by the least squares method. The curvature of the arc can be obtained by estimating the parameter of the arc.

In S405, the traveling lane recognition unit 202 determines whether the estimated curvature is equal to or less than a predetermined value, and if the curvature is equal to or less than the predetermined value, advances the processing to S406, and if not, terminates the processing. In a case where the curvature of the traveling road boundary is large, risk calculation using a virtual traveling lane may not be appropriate, and thus the traveling lane recognition unit 202 does not continue the driving assistance processing.

In S406, the virtual traveling lane generation unit 203 converts the information on the traveling lane recognized by the target recognition unit 201 and the state of the target recognized by the traveling lane recognition unit 202 into a virtual traveling lane which is a straight traveling lane.

FIG. 8 illustrates an example in which virtual traveling lane information is generated on the basis of traveling lane information and a position of a target (vehicle 303). The virtual traveling lane generation unit 203 maps the position of the traveling road boundary of the traveling lane 302 and the position of the target on the traveling road boundary of the traveling lane 304, for example, by the method described above with reference to FIG. 3. In the present embodiment, when the position of the target is converted into a virtual traveling lane, the position of the recognized target is offset using a geometric calculation such as using a trigonometric function. For example, a right triangle including a side connecting an intersection ((0, y) in self-vehicle coordinate system) between the position of the vehicle 301 and the traveling road boundary and the position where the vehicle 303 existed may be formed, and the position of the vehicle 305 may be offset to a position forming a triangle similar to the right triangle. In this way, simple and high-speed calculation can be achieved, and the position of the target on the virtual traveling lane can be given more accurately by the offset of the position of the target.

In S407, as described above, the risk calculation unit 204 sets the search region for calculating the risk on the virtual traveling lane, and calculates the risk including the influence of the target in the search region on the virtual traveling lane. As described above, in order to set the risk potential on the virtual traveling lane, the risk calculation unit 204 calculates the risk using, for example, the risk value of the risk potential in the search region on the virtual traveling lane.

In S408, if the calculated risk is equal to or more than a predetermined value, the risk calculation unit 204 advances the processing to S409, and if not, terminates the processing without making the notification.

In S409, the notification unit 206 notifies the driver in response to an instruction from the risk calculation unit 204, for example. As described above, the notification unit 206 notifies the driver of a predetermined warning sound or a voice using a natural language (including an expression representing a recognized target). When the notification is terminated, the notification unit 206 then terminates the series of operations of the driving assistance processing.

Note that in the series of operations of the driving assistance processing described above, the case where the notification is performed when the calculated risk is equal to or more than a predetermined value has been described as an example, but any of the automated traveling by the travel control unit 205 may be performed. Alternatively, both the notification by the notification unit 206 and the automated traveling by the travel control unit 205 may be performed.

As described above, in the above embodiment, the vehicle 1 generates information on a virtual traveling lane that is a straight traveling lane on the basis of information on the recognized traveling lane and the state of the recognized target. At this time, when the traveling lane has a predetermined road shape including a curved shape, the vehicle 1 converts each position of the traveling lane so that a curved portion of the traveling lane becomes a straight traveling lane along the traveling direction, and generates information of the virtual traveling lane. Furthermore, the vehicle 1 sets a search region for calculating a risk, which is an index value indicating a degree to which the moving object should avoid entry, on the virtual traveling lane, and calculates a risk in the set search region. In this way, it is not necessary to perform processing specific to the curved road according to the curvature when calculating the risk and notifying the driver, and the processing for calculating the risk and notifying the driver can be simplified and speeded up. In addition, it is possible to suppress a decrease in processing accuracy. In other words, it is possible to suppress a decrease in accuracy in risk calculation even when traveling on a movement route having a road shape including a curved shape.

### Summary of Embodiments

### (Item 1)

A control apparatus (for example, 22) comprising:
a target recognition unit (for example, 201) configured to recognize a state of a target outside a moving object (for example, 1);
a traveling lane recognition unit (for example, 202) configured to recognize a traveling lane on a movement route on which the moving object travels;
a generation unit (for example, 203) configured to generate information of a virtual traveling lane which is a straight traveling lane on the basis of information of the recognized traveling lane and a state of the recognized target;
a setting unit (for example, 204) configured to set, on the virtual traveling lane, a search region for calculating a risk that is an index value indicating a degree to which the moving object should avoid entry; and
a calculation unit (for example, 204) configured to calculate the risk in the set search region, wherein
in a case where the traveling lane has a road shape including a curved shape, the generation unit converts each position of the traveling lane so that a curved portion of the traveling lane becomes a straight traveling lane along a traveling direction, and generates information of the virtual traveling lane.

According to this embodiment, it is possible to suppress a decrease in accuracy in risk calculation even when traveling on a movement route having a road shape including a curved shape.

### (Item 2)

The control apparatus according to item 1, wherein
the target recognition unit recognizes a position of a target, and
the generation unit generates the information of the virtual traveling lane by converting a position of the recognized target onto the virtual traveling lane.

According to this embodiment, it is possible to suppress a decrease in accuracy when calculating a risk for a target even when traveling on a movement route having a road shape including a curved shape.

### (Item 3)

The control apparatus according to item 1, wherein the generation unit does not generate the information of the virtual traveling lane (for example, S405) in a case where a curvature of a traveling road boundary of the traveling lane is larger than a predetermined value.

According to this embodiment, when it is not suitable to generate a virtual traveling lane that is a straight traveling lane, it is possible to refrain from generating the virtual traveling lane.

### (Item 4)

The control apparatus according to item 1, further comprising a determination unit (for example, 205, 206) configured to determine an action of the moving object on the basis of the calculated risk.

According to this embodiment, it is possible to achieve vehicle control according to a risk.

### (Item 5)

The control apparatus according to item 4, wherein
the risk corresponds to a possibility of collision between the moving object and the recognized target in the search region, and
the determination unit determines the action of the moving object on the basis of the possibility of collision between the moving object and the recognized target.

According to this embodiment, it is possible to suppress a decrease in accuracy when calculating the possibility of collision with a target.

### (Item 6)

The control apparatus according to item 4, wherein the action of the moving object includes notification to a driver of the moving object.

According to this embodiment, it is possible to suppress a decrease in accuracy of notification based on a risk when traveling on a movement route including a curve.

### (Item 7)

The control apparatus according to item 4, wherein the action of the moving object includes automated traveling of the moving object that does not require a traveling operation by a driver or automated traveling for assisting the traveling operation by the driver.

According to this embodiment, it is possible to suppress a decrease in accuracy of automated traveling based on a risk when traveling on a movement route including a curve.

### (Item 8)

The control apparatus according to item 7, wherein in a case where automated traveling of the moving object that does not require a traveling operation by a driver is performed, the determination unit determines a travel route of the moving object on the basis of the calculated risk and controls at least one of speed and steering of the moving object according to the travel route.

According to this embodiment, it is possible to perform various types of control related to automated traveling of a moving object according to the travel route based on the calculated risk.

### (Item 9)

The control apparatus according to item 1, further comprising a determining unit configured to determine whether the traveling lane has a road shape including a curved shape by using information of a traveling road boundary of the traveling lane (for example, S402), wherein
the generation unit does not generate the information of the virtual traveling lane in a case where the traveling lane does not have a road shape including a curved shape.

According to this embodiment, risk calculation using a virtual traveling lane can be applied to an appropriate curved road.

### (Item 10)

The control apparatus according to item 9, wherein the determining unit determines whether the traveling lane has a road shape including a curved shape on the basis of a curvature of the traveling road boundary of the traveling lane (for example, S405).

According to this embodiment, the curvature of a curved road can be considered in determining whether the curved road is an appropriate curved road.

### (Item 11)

The control apparatus according to item 10, wherein the determining unit determines that the traveling lane has a road shape including a curved shape in a case where the curvature of the traveling road boundary of the traveling lane is a curvature within a predetermined range (for example, S405).

According to this embodiment, it is possible to prevent risk calculation using a virtual traveling lane from being applied to a curved road having a large curvature.

### (Item 12)

The control apparatus according to item 10, wherein the determining unit estimates the curvature of the traveling road boundary of the traveling lane by fitting the traveling road boundary of the traveling lane with an arc (for example, S404).

According to this embodiment, it is possible to dynamically acquire the curvature of a traveling road boundary of a traveling lane.

### (Item 13)

The control apparatus according to item 2, wherein when converting the position of the recognized target onto the virtual traveling lane, the generation unit offsets the position of the recognized target, on the virtual traveling lane, such that the position of the recognized target moves away from the position of the moving object in a traveling direction of the moving object.

According to this embodiment, when traveling on a movement route including a curve, the positional relationship between the vehicle 301 and a target in the traveling lane 302 can be more accurately reflected on the virtual traveling lane 304 by simple calculation.

### (Item 14)

The control apparatus according to item 13, wherein when converting the position of the recognized target onto the virtual traveling lane, the generation unit offsets the position of the recognized target by using a geometric calculation.

According to this embodiment, when traveling on a movement route including a curve, a simpler and faster calculation can be achieved.

The invention is not limited to the foregoing embodiments, and various variations/changes are possible within the spirit of the invention.

What is claimed is:

1. A control apparatus comprising:
one or more processors; and
a memory storing instructions which, when the instructions are executed by the one or more processors, cause the control apparatus to function as:
a target recognition unit configured to recognize a state of a target outside a moving object;
a traveling lane recognition unit configured to recognize a traveling lane on a movement route on which the moving object travels;
a generation unit configured to generate information of a virtual traveling lane which is a straight traveling lane on the basis of information of the recognized traveling lane and a state of the recognized target;
a setting unit configured to set, on the virtual traveling lane, a search region for calculating a risk that is an index value indicating a degree to which the moving object should avoid entry; and
a calculation unit configured to calculate the risk in the set search region, wherein
in a case where the traveling lane has a road shape including a curved shape, the generation unit converts each position of the traveling lane so that a curved portion of the traveling lane becomes a straight traveling lane along a traveling direction, and generates information of the virtual traveling lane.

2. The control apparatus according to claim 1, wherein
the target recognition unit recognizes a position of a target, and
the generation unit generates the information of the virtual traveling lane by converting a position of the recognized target onto the virtual traveling lane.

3. The control apparatus according to claim 1, wherein the generation unit does not generate the information of the virtual traveling lane in a case where a curvature of a traveling road boundary of the traveling lane is larger than a predetermined value.

4. The control apparatus according to claim 1, the instructions further cause the control apparatus to function as a determination unit configured to determine an action of the moving object on the basis of the calculated risk.

5. The control apparatus according to claim 4, wherein
the risk corresponds to a possibility of collision between the moving object and the recognized target in the search region, and
the determination unit determines the action of the moving object on the basis of the possibility of collision between the moving object and the recognized target.

6. The control apparatus according to claim 4, wherein the action of the moving object includes notification to a driver of the moving object.

7. The control apparatus according to claim 4, wherein the action of the moving object includes automated traveling of the moving object that does not require a traveling operation by a driver or automated traveling for assisting the traveling operation by the driver.

8. The control apparatus according to claim 7, wherein in a case where automated traveling of the moving object that does not require a traveling operation by a driver is performed, the determination unit determines a travel route of the moving object on the basis of the calculated risk and controls at least one of speed and steering of the moving object according to the travel route.

9. The control apparatus according to claim 1, the instructions further cause the control apparatus to function as a determining unit configured to determine whether the traveling lane has a road shape including a curved shape by using information of a traveling road boundary of the traveling lane, wherein
the generation unit does not generate the information of the virtual traveling lane in a case where the traveling lane does not have a road shape including a curved shape.

10. The control apparatus according to claim 9, wherein the determining unit determines whether the traveling lane has a road shape including a curved shape on the basis of a curvature of the traveling road boundary of the traveling lane.

11. The control apparatus according to claim 10, wherein the determining unit determines that the traveling lane has a road shape including a curved shape in a case where the curvature of the traveling road boundary of the traveling lane is a curvature within a predetermined range.

12. The control apparatus according to claim 10, wherein the determining unit estimates the curvature of the traveling road boundary of the traveling lane by fitting the traveling road boundary of the traveling lane with an arc.

13. The control apparatus according to claim 2, wherein when converting the position of the recognized target onto the virtual traveling lane, the generation unit offsets the position of the recognized target, on the virtual traveling lane, such that the position of the recognized target moves away from the position of the moving object in a traveling direction of the moving object.

14. The control apparatus according to claim 13, wherein when converting the position of the recognized target onto the virtual traveling lane, the generation unit offsets the position of the recognized target by using a geometric calculation.

15. A control method of a control apparatus comprising:
recognizing a state of a target outside a moving object;
recognizing a traveling lane on a movement route on which the moving object travels;
generating information of a virtual traveling lane which is a straight traveling lane on the basis of information of the recognized traveling lane and a state of the recognized target;
setting, on the virtual traveling lane, a search region for calculating a risk that is an index value indicating a degree to which the moving object should avoid entry; and
calculating the risk in the set search region, wherein
in the generating, in a case where the traveling lane has a road shape including a curved shape, each position of the traveling lane is converted so that a curved portion of the traveling lane becomes a straight traveling lane along a traveling direction, and information of the virtual traveling lane is generated.

16. A non-transitory computer-readable storage medium storing a program for performing the control method of the control apparatus, the control method comprising:
recognizing a state of a target outside a moving object;
recognizing a traveling lane on a movement route on which the moving object travels;
generating information of a virtual traveling lane which is a straight traveling lane on the basis of information of the recognized traveling lane and a state of the recognized target;
setting, on the virtual traveling lane, a search region for calculating a risk that is an index value indicating a degree to which the moving object should avoid entry; and
calculating the risk in the set search region, wherein
in the generating, in a case where the traveling lane has a road shape including a curved shape, each position of the traveling lane is converted so that a curved portion of the traveling lane becomes a straight traveling lane along a traveling direction, and information of the virtual traveling lane is generated.
